(19) United States
(12) Patent Application Publication
(10) Pub. No.: US 2017/0335023 A1
(43) Pub. Date: Nov. 23, 2017

(54) PROCESS FOR THE SEPARATION OF A STREAM COMPRISING VAPOUR AND SOLIDS IN A SEPARATION VESSEL

(71) Applicant: INEOS EUROPE AG, Vaud (CH)

(72) Inventors: Fabrice Betton, Lyon (FR); Kevin Peter RAMSAY, West Lothian (GB)

(21) Appl. No.: 15/513,605

(22) PCT Filed: Sep. 22, 2015
(86) PCT No.: PCT/EP2015/071675

§ 371 Date: Mar. 23, 2017

(30) Foreign Application Priority Data
Sep. 25, 2014 (EP) 14186330.8

(51) Int. Cl. C08F 6/00; B01D 19/00; B01D 45/10; B01D 5/00; C08J 11/02; B01D 50/00

(52) U.S. Cl. CPC C08F 6/005; C08J 11/02; B01D 50/002; B01D 45/10; B01D 5/0057; B01D 5/0072; B01D 5/0069; B01D 19/0068

(57) ABSTRACT

The present invention relates to vapour-solids separations, and in particular provides a process for the separation of a stream comprising vapour and a stream comprising solids from a stream comprising vapour and solids using a separation vessel, said separation vessel having: a. a first inlet for the stream to be separated, b. a liquid outlet, c. a vapour outlet, d. a demister located on the vapour outlet, and e. a second inlet by which liquid can be passed to the demister said process comprising (i) passing the stream comprising vapour and solids through the first inlet and in to the separation vessel, (ii) recovering from the vapour outlet a vapour stream which comprises vapour from the stream comprising vapour and solids and which vapour stream has passed through the demister in the separation vessel, (iii) passing to the separation vessel, via the second inlet, a first liquid stream which contacts the vapour stream in the demister, and (iv) recovering from the liquid outlet a second liquid stream which comprising the solids from the stream comprising vapour and solids, and liquid from the first liquid stream.

The present invention relates to vapour-solids separations.

Vapour-solids separation vessels are widely used in the art to enable, as the name suggests, separation of vapour and solids phases. Similarly there are also widely used in the art vapour-liquid separation vessels to enable, as the name suggests, separation of vapour and liquids phases.

In vapour-liquid separation vessels, in general, a stream comprising liquid and vapour is passed to a vessel wherein a continuous liquid phase forms in the bottom of the vessel, with a vapour phase above this. The liquid phase can then be removed from the base of the vessel, and vapour overhead.

The vapour phase may nevertheless contain entrained droplets of liquid. These droplets can coalesce leading to liquid collecting at low points in the subsequent equipment, or leading to slugs of liquid which can contact the subsequent equipment. To avoid this, and also to improve the separation generally, it is known to put devices, known as demisters, in the top of the vapour-liquid separation vessel through which the vapour must pass prior to exiting the vessel.

The demisters provide a tortuous path which causes the vapour to contact the surfaces thereof. This leads to condensation of the droplets of liquid which then run back out of the demister and into the liquid phase in the base of the vapour-liquid separation vessel. The vapour stream after passing through the demister thus has a significantly reduced liquid content.

The present invention relates to a variant of the vapour-liquid separation vessels where the vessel is used to separate a stream comprising vapour and solids, and liquid is introduced through a second inlet to the demister.

Thus, in a first aspect the present invention provides a process for the separation of a stream comprising vapour and a stream comprising solids from a stream comprising vapour and solids using a separation vessel, said separation vessel having:
a. a first inlet for the stream to be separated,
b. a liquid outlet,
c. a vapour outlet,
d. a demister located on the vapour outlet, and
e. a second inlet by which liquid can be passed to the demister
   said process comprising
(i) passing the stream comprising vapour and solids through the first inlet and in to the separation vessel,
(ii) recovering from the vapour outlet a vapour stream which comprises vapour from the stream comprising vapour and solids and which vapour stream has passed through the demister in the separation vessel,
(iii) passing to the separation vessel, via the second inlet, a first liquid stream which contacts the vapour stream in the demister, and
(iv) recovering from the liquid outlet a second liquid stream which comprising the solids from the stream comprising vapour and solids, and liquid from the first liquid stream.

In the present invention, to enhance solids removal in the demister, a liquid stream (“first liquid stream”) is passed to the demister. This traps solids from the vapour stream passing through the demister leading to a significant reduction in the solids in the vapour stream.

The first liquid stream may be passed to the demister by any suitable method, but a preferred method is to use a spray nozzle which sprays the liquid onto the demister.

The first liquid stream generally contacts the demister and runs downwards through and/or off of the demister.

The demister which is present in the present invention, even though used in the presence of solids, may generally be a demister conventionally used to enhance removal of liquid mist entrained in a vapour stream by aggregating the liquid mist into droplets which are heavy enough to separate. Such devices are well-known. Examples include parallel plate separators, vane packs, baffles or other structures which aggregate a liquid mist into droplets.

The demister is preferably what is known in the art as a “vane pack”, “vane-type demister” or “vane separator”. Such devices are well-known for vapour-liquid separation vessels and comprise a series of vanes in which the stream is forced to change direction a number of times. In the use of such systems for vapour-liquid separation this causes contact of the streams with the walls, causing any entrained liquid to wet the surface and coalesce. This liquid then runs down and off of the vanes. In the separation vessel of the present invention this maximises contact with the first liquid stream, enhancing solids removal. Such devices will herein be referred to as “vane packs”.

In a preferred embodiment the demister is generally vertically orientated, which as used herein means the demister is vertical or within 30° of vertical. Preferably it is vertical.

The vertical orientation means that liquid sprayed near the top of the demister runs down through the height of the demister, which improves the effectiveness of the liquid contact and maximises the separation. This can also minimise the quantity of the first liquid stream needed for effective separation.

Preferably the first liquid stream is sprayed onto the demister perpendicularly from a generally horizontally orientated second inlet.

The solids from the stream comprising vapour and solids in the present invention are thus recovered from the separation vessel in the second liquid stream recovered from the liquid outlet. The present invention minimises the entrainment of solids in the vapour stream. This stream may then be passed to process equipment, such as compressors, without concern or with reduced concern about solids therein.

The liquid stream which is passed to the separation vessel via the second inlet (first liquid stream) may be a fresh liquid stream. Alternatively, and preferably, the first liquid stream may comprise liquid recovered and recycled from the liquid outlet i.e. from the second liquid stream.

The stream comprising vapour and solids may be from any suitable source. On entry to the separation vessel the stream may also comprise liquid or a vapour component which condenses to form liquid in the separation vessel. Preferably it comprises vapour, liquid and solids prior to entry to the separation vessel.

The liquid outlet is typically at the base of the separation vessel.

The orientation and location of the first inlet is not especially critical. It may, for example, enter the separation vessel broadly perpendicular to the wall at the entry point, or tangentially to the inner surface of the separation vessel. Preferably the first inlet is generally horizontally orientated, which as used herein means the demister is horizontal or within 30° of horizontal.

It may enter at any suitable height, but usually the first inlet is at a lower height on the separation vessel than the second inlet. The height is most typically centrally located in the separation vessel by height, defined herein as being at a height between 25% and 75% of the total height of the separation vessel.

Any liquid deriving from the stream comprising vapour and solids is recovered in the second liquid stream from the liquid outlet.

In a most preferred embodiment the stream comprising vapour and solids is a stream from the degassing section of a polymerisation process. The solids are then polymer fines which are entrained with the recovered vapour. The stream will generally also comprise monomer and at least one of comonomer and inert hydrocarbons.

In some embodiments the stream from the degassing section of a polymerisation process may also comprise one or more organoaluminium compounds, such as trialkyl aluminium compounds, for example triethylaluminium (TEAL). Such compounds can be added in polymerisation processes as co-catalysts or scavengers. A further advantage of the present invention when applied to such streams is that the introduction of the first liquid stream to the demister has also been found to enhance the removal of such compounds, leading to a significant reduction in the organoaluminium compounds in the vapour stream.

These compounds are pyrophoric and if present special precautions have to be taken to ensure their destruction before maintenance can be performed. Further, if present then materials used, such as for filters and compressor seals, must be chosen accordingly. Hence their enhanced removal is a significant further advantage.

The stream after initial separation in the degassing section will be a vapour stream comprising the above-mentioned polymer fines. The stream may be passed through a relatively coarse filter to remove larger solids. Such filters are generally relatively coarse because removal of all fines is not only difficult but a fine filter may lead to condensation of heavier components and the filter would block rapidly due to reaction of the fine particles, which can still be catalytically active.

Regardless of whether a coarse filter is used, prior to the separation vessel the stream may be cooled, and preferably may be cooled sufficiently to condense heavier components, such as comonomers and inert hydrocarbons (such as isobutane or pentane) which then form a liquid phase prior to entry to the separation vessel.

Hence, in a preferred embodiment the present invention provides a process comprising
a) passing a polymer containing stream to a degassing section and recovering from the degassing section a stream comprising gaseous monomer, a gaseous condensable component other than the monomer and polymer fines,
b) optionally passing said stream comprising gaseous monomer, a gaseous condensable component other than the monomer and polymer fines through a filter to remove some but not all of the polymer fines,
c) passing said stream comprising gaseous monomer, a gaseous condensable component other than the monomer and polymer fines to a condenser wherein at least a portion of the gaseous condensable component is condensed to form liquid, thereby providing a stream comprising gaseous monomer, a liquid component and polymer fines, and
d) passing said stream to a separation vessel having:
   a. a first inlet by which the stream comprising gaseous monomer, a liquid component and polymer fines is passed to the separation vessel
   b. a liquid outlet,
   c. a vapour outlet,
   d. a demister located on the vapour outlet, and
   e. a second inlet by which liquid can be passed to the demister;
e) recovering from the vapour outlet a vapour stream which comprises vapour from the stream comprising vapour and solids and which vapour stream has passed through the demister in the separation vessel,
f) passing to the separation vessel, via the second inlet, a liquid stream which contacts the vapour stream in the demister, and
g) recovering from the liquid outlet a liquid stream which comprising the solids from the stream comprising vapour and solids, and liquid from the liquid stream.

The gaseous condensable component other than the monomer/liquid component (after condensing) is preferably a comonomer or an inert hydrocarbon such as butane, pentane or hexane. Both comonomer and inert hydrocarbons may be present.

In this aspect the first liquid stream is preferably a portion of the liquid recovered from the liquid outlet (i.e. of the second liquid stream), and will therefore comprise this liquid component. The portion of the second liquid stream recycled as the first liquid stream may be filtered to remove solids although this is not necessary.

Alternatively fresh liquid, such as “make-up” inert hydrocarbon or comonomer, may be used as all or part of the first liquid stream.

The vapour stream recovered from the vapour outlet in this embodiment will generally comprise monomer. It will generally also comprise other non-condensed gaseous components. such as nitrogen and hydrogen. In general it is desired to recycle all or a portion of this stream to the polymerisation process, which may comprise treatment of the stream to remove undesired impurities, and will generally require compression. Solids in the stream can cause problems during such steps, for example in compressors (e.g. seals issues), membranes (e.g. blocking or contamination issue) or in lines generally (e.g. blocking due to settling out of solids). The present invention minimises the entrainment of solids in the vapour stream so that this stream may then be passed to process equipment used for such steps without concern about solids therein.

As already noted in respect of the option to filter to remove larger particles prior to the separation vessel, polymer fines can comprise active catalyst species. A fine filter on the overhead of the separation vessel would generally foul relatively rapidly causing blockage of the filter. The rate of such fouling can also be enhanced by any liquid not removed by a demister in a conventional vapour-liquid separation system because the filter can also cause such liquid to condense. The filter then needs to be taken “out of service” and cleaned. The present invention allows such filters to be removed from the vapour outlet of the separation vessel. Alternatively, even when still used, the large reduction in fines in the vapour reduces the rate at which such filters block.

As already noted the separation vessel of the present invention is a variant of the conventional vapour-liquid separation vessels but where the vessel is used to separate a stream comprising vapour and solids, and in particular where liquid is introduced through a second inlet to the demister in the separation vessel.

The separation vessel is preferably not a fractionation tower or other separator with multiple separation stages. Preferably it is a tank with the liquid outlet being at the base and the vapour outlet at the top. In use a continuous liquid phase can form in the bottom of the separation vessel with a vapour phase above this.

More preferably the separation vessel has a single liquid outlet and a single vapour outlet. Most preferably the separation vessel has a single liquid outlet and a single vapour outlet, and the only inlets to the separation vessel are the first and second inlets.

In another aspect the present invention relates to a separation vessel suitable for use in the process of the present invention. In particular, the present invention provides an apparatus which comprises a separation vessel having:
a. a first inlet for a stream to be separated,
b. a liquid outlet,
c. a vapour outlet, and
d. a demister located on the vapour outlet,
   characterised in that the separation vessel also comprises a second inlet which is a liquid inlet by which liquid can be passed to the demister.

In use the second inlet may be used to feed fresh liquid. Alternatively, it may be used to feed a portion of the liquid removed through the liquid outlet. In this embodiment the liquid outlet is connected, externally to the separation vessel, to the second inlet.

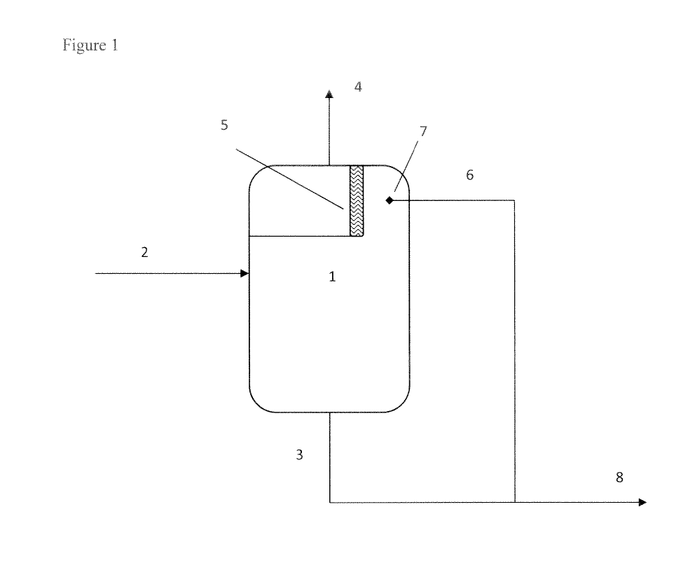

FIG. 1 is a schematic diagram showing a separation vessel according to the preferred embodiment. In particular, FIG. 1 shows a separation vessel (1) which has a first inlet for a stream to be separated (fed via line 2), a liquid outlet (via line 3), a vapour outlet (via line 4), a demister located on the vapour outlet (5), and a second inlet by which liquid can be passed to the demister (via line 6 and a nozzle 7). As shown in FIG. 1, the second inlet is connected to the liquid outlet, so that a portion of the liquid exiting the separation vessel (1) via the liquid outlet/line 3 can be passed to the second inlet. The remainder of the liquid exiting the separation vessel (I) via the liquid outlet/line 3 is passed via line 8 for further use as required. A pump (not shown) can be provided in the liquid outlet line (3) prior to the separation of the liquid between lines (6) and (8).

Although not shown, other internals can be present, including a vortex breaker on the vapour outlet and/or one or more baffles to aid distribution of the stream to be separated from the first inlet.

In the process of the present invention, a stream comprising vapour and solids is passed via line 2 through the first inlet and in to the separation vessel (1). There is recovered from the vapour outlet, via line (4) a vapour stream which comprises vapour from the stream comprising vapour and solids and which vapour stream has passed through the demister (5) in the separation vessel (1). Also passed to the separation vessel, via line 6/the second inlet is a first liquid stream which is sprayed via nozzle (7) onto the demister (5) where it contacts the vapour stream. There is recovered from the liquid outlet, via line 3. a second liquid stream which comprising the solids from the stream comprising vapour and solids, and liquid from the first liquid stream. A portion of this is recycled as the first liquid stream, whilst the remainder is recovered via line 8.

### EXAMPLE

A fluidised bed ethylene polymerisation process with a capacity of 300 ktpa is provided with a separation vessel as shown in FIG. 1.

A polyethylene containing stream is recovered from a fluidised bed polymerisation reactor and passed to a degassing section from which there is recovered a stream comprising ethylene, comonomer, inert hydrocarbons and polymer fines.

The stream is passed through a coarse filter designed to remove particles larger than 50 microns, and then cooled. The total polymer fines downstream of the filter may be present at levels up to approximately 1500 ppm by weight.

The stream, after the coarse filter, is obtained at a rate of approximately 10 te/hr. It is in the vapour phase but comprises approximately 10% by weight of inert hydrocarbons and comonomer which may be partially condensed.

This stream is passed via line 2 through the first inlet and in to the separation vessel (1). Also passed to the separation vessel, via line 6/the second inlet and a nozzle (7) is a first liquid stream comprising principally inert hydrocarbons and comonomer at a rate of 3.6 te/hr, which contacts the vapour stream in the demister (5).

There is recovered from the liquid outlet, via line 3, a second liquid stream at a rate of approximately 4.6 te/hr, which comprising the majority of the solids and liquid from the stream comprising vapour, liquid and solids as well as the majority of the liquids from the first liquid stream. 3.6 te/hr of this stream is recycled as the first liquid stream, whilst the remainder, approximately 1 te/hr, is recovered via line 8 including polymer fines.

There is recovered from the vapour outlet, via line (4) a vapour stream which comprises monomer and isopentane at a rate of approximately 9 te/hr. The solids content of this stream is less than 15 ppm by weight.

This stream is passed to a compressor where it is compressed for re-use in the process.

Operation of the compressor proceeds without fouling due to fines in the vapour stream.

1-12. (canceled)

13. A process for the separation of a stream comprising vapour and a stream comprising solids from a stream comprising vapour and solids using a separation vessel, said separation vessel having:
a. a first inlet for the stream to be separated,
b. a liquid outlet,
c. a vapour outlet,
d. a demister located on the vapour outlet, and
e. a second inlet by which liquid can be passed to the demister said process comprising
(i) passing the stream comprising vapour and solids through the first inlet and in to the separation vessel,
(ii) recovering from the vapour outlet a vapour stream which comprises vapour from the stream comprising vapour and solids and which vapour stream has passed through the demister in the separation vessel,
(iii) passing to the separation vessel, via the second inlet, a first liquid stream which contacts the vapour stream in the demister, and
(iv) recovering from the liquid outlet a second liquid stream which comprising the solids from the stream comprising vapour and solids, and liquid from the first liquid stream,
wherein the vapour stream recovered from the vapour outlet is passed to a compressor.

14. A process as claimed in claim 13 wherein the demister is a vane pack demister.

15. A process as claimed in claim 13 wherein the first liquid stream is a fresh liquid stream.

16. A process as claimed in claim 13 wherein the first liquid stream comprises liquid recovered and recycled from the liquid outlet.

17. A process as claimed in claim 13 wherein the stream comprising vapour and solids also comprises liquid, which liquid is recovered in the second liquid stream from the liquid outlet.

18. A process as claimed in claim 13 wherein the stream comprising vapour and solids is a stream from the degassing section of a polymerisation process and the solids are polymer fines.

19. A process according to claim 18 comprising
a) passing a polymer containing stream to the degassing section of a polymerisation process and recovering from the degassing section a stream comprising gaseous monomer, a gaseous condensable component other than the monomer and polymer fines,
b) optionally passing said stream comprising gaseous monomer, a gaseous condensable component other than the monomer and polymer fines through a filter to remove some but not all of the polymer fines,
c) passing said stream comprising gaseous monomer, a gaseous condensable component other than the monomer and polymer fines to a cooler,
d) passing said cooled stream through the first inlet and in to the separation vessel.

20. A process according to claim 19 wherein step (c) comprises passing the stream comprising gaseous monomer, a gaseous condensable component other than the monomer and polymer fines to a condenser wherein at least a portion of the gaseous condensable component is condensed to form liquid, thereby providing a stream comprising gaseous monomer, a liquid component and polymer fines, which stream comprising gaseous monomer, a liquid component and polymer fines is passed through the first inlet and in to the separation vessel in step (d)

21. A process according to claim 18 wherein the stream from the degassing section of a polymerisation process also comprises one or more organoaluminium compounds.

22. A process as claimed in claim 13 wherein the separation vessel is a tank with the only internals being the demister.

23. An apparatus which comprises a separation vessel having:
a. a first inlet for a stream to be separated,
b. a liquid outlet,
c. a vapour outlet, and
d. a demister located on the vapour outlet,
characterised in that the separation vessel also comprises a second inlet which is a liquid inlet by which liquid can be passed to the demister, and
further wherein the vapour outlet is connected to a compressor such that a vapour stream recovered from the vapour outlet is passed to the compressor.

24. Apparatus according to claim 23 wherein the liquid outlet is connected, externally to the separation vessel, to the second inlet.

25. A process as claimed in claim 14 wherein the first liquid stream is a fresh liquid stream.

26. A process as claimed in claim 14 wherein the first liquid stream comprises liquid recovered and recycled from the liquid outlet.

27. A process as claimed in claim 14 wherein the stream comprising vapour and solids also comprises liquid, which liquid is recovered in the second liquid stream from the liquid outlet.

28. A process as claimed in claim 14 wherein the stream comprising vapour and solids is a stream from the degassing section of a polymerisation process and the solids are polymer fines.

29. A process according to claim 28 comprising
a) passing a polymer containing stream to the degassing section of a polymerisation process and recovering from the degassing section a stream comprising gaseous monomer, a gaseous condensable component other than the monomer and polymer fines,
b) optionally passing said stream comprising gaseous monomer, a gaseous condensable component other than the monomer and polymer fines through a filter to remove some but not all of the polymer fines,
c) passing said stream comprising gaseous monomer, a gaseous condensable component other than the monomer and polymer fines to a cooler,
d) passing said cooled stream through the first inlet and in to the separation vessel.

30. A process according to claim 29 wherein step (c) comprises passing the stream comprising gaseous monomer, a gaseous condensable component other than the monomer and polymer fines to a condenser wherein at least a portion of the gaseous condensable component is condensed to form liquid, thereby providing a stream comprising gaseous monomer, a liquid component and polymer fines, which stream comprising gaseous monomer, a liquid component and polymer fines is passed through the first inlet and in to the separation vessel in step (d)

31. A process according to claim 28 wherein the stream from the degassing section of a polymerisation process also comprises one or more organoaluminium compounds.

32. A process as claimed in claim 14 wherein the separation vessel is a tank with the only internals being the demister.
